(19) United States
(12) Patent Application Publication
(10) Pub. No.: US 2022/0038472 A1
(43) Pub. Date: Feb. 3, 2022

(54) INFORMATION PROCESSING DEVICE, CONTROL METHOD, AND PROGRAM

(71) Applicant: NEC corporation, Minato-ku, Tokyo (JP)

(72) Inventors: Jun NISHIOKA, Tokyo (JP); Yoshiaki SAKAE, Tokyo (JP); Kazuhiko ISOYAMA, Tokyo (JP); Etsuko ICHIHARA, Tokyo (JP)

(73) Assignee: NEC corporation, Minato-ku, Tokyo (JP)

(21) Appl. No.: 17/277,379

(22) PCT Filed: Sep. 26, 2018
(86) PCT No.: PCT/JP2018/035744

§ 371 Date: Mar. 18, 2021

(51) Int. Cl. H04L 29/06; H04W 24/08

(52) U.S. Cl. CPC H04L 63/1416; H04W 24/08

(57) ABSTRACT

An information processing apparatus (2000) extracts, from a communication history (20) representing a history of network communication performed by each of a plurality of mobile terminals (10), a communication history (20) indicating communication related to a similar attack. Herein, the communication history (20) includes positional information about the mobile terminal (10). The information processing apparatus (2000) generates attack information related to an attack on the mobile terminal (10) by using positional information indicated by each of the extracted communication histories (20), and outputs the generated attack information.

### TECHNICAL FIELD

The present invention relates to security of network communication.

### BACKGROUND ART

There is a terminal that performs network communication while moving, such as a terminal mounted on a vehicle. Hereinafter, such a terminal is referred to as a mobile terminal. Then, a system for performing abnormality detection related to communication by such a mobile terminal has been developed. For example, PTL 1 is taken as an example. PTL 1 discloses a technique for determining whether an abnormality occurs in a radio LAN in a position determined by positional information by using statistical information about communication in the radio LAN and positional information about a radio terminal in an environment in which the radio terminal is connected to a radio WAN via the radio LAN.

### RELATED DOCUMENT

### Patent Document

[PTL 1] Japanese Patent Application Publication No. 2017-022557

### SUMMARY OF THE INVENTION

### Technical Problem

A mobile terminal has various types of network environments to be used as compared to a stationary terminal having a fixed position. For example, a mobile terminal may perform communication via an access point installed in various stores. Thus, there is a high risk that a mobile terminal suffers damage of an attack affecting communication. No mention is made of attack damage to a mobile terminal in PTL 1.

The present invention has been made in view of the above-described problem. One of objects of the present invention is to provide a technique for reducing a probability that a mobile terminal suffers attack damage.

### Solution to Problem

An information processing apparatus according to the present invention includes 1) an extraction unit that extracts, from a communication history representing a history of network communication performed by each of a plurality of mobile terminals, a communication history indicating communication related to a similar attack, the communication history including positional information about the mobile terminal, 2) a generation unit that generates attack information related to an attack on a mobile terminal by using positional information indicated by each of the extracted communication histories, and 3) an output unit that outputs the generated attack information.

A control method according to the present invention is executed by a computer. The control method includes 1) an extraction step of extracting, from a communication history representing a history of network communication performed by each of a plurality of mobile terminals, a communication history indicating communication related to a similar attack, the communication history including positional information about the mobile terminal, 2) a generation step of generating attack information related to an attack on a mobile terminal by using positional information indicated by each of the extracted communication histories, and 3) an output step of outputting the generated attack information.

A program according to the present invention causes a computer to execute each step included in the control method according to the present invention.

### Advantageous Effects of Invention

According to the present invention, a technique for reducing a probability that a mobile terminal suffers attack damage is provided.

### BRIEF DESCRIPTION OF THE DRAWINGS

The above-described object, the other objects, features, and advantages will become more apparent from a suitable example embodiment described below and the following accompanying drawings.

FIG. 1 is a diagram representing an outline of an operation of an information processing apparatus according to an example embodiment 1.

FIG. 2 is a diagram illustrating a configuration of the information processing apparatus according to the example embodiment 1.

FIG. 3 is a diagram illustrating a computer for achieving the information processing apparatus.

FIG. 4 is a flowchart illustrating a flow of processing performed by the information processing apparatus according to the example embodiment 1.

FIG. 5 is a diagram illustrating a configuration of a communication history 20 in a table format.

FIG. 6 is a diagram illustrating a case where a change in positional information is small in time series data of the positional information.

FIG. 7 is a diagram illustrating a case where a change in positional information is great in time series data of the positional information.

### DESCRIPTION OF EMBODIMENTS

Hereinafter, an example embodiment of the present invention will be described with reference to the drawings. Note that, in all of the drawings, a similar component has a similar reference numeral, and description thereof will be appropriately omitted. Further, in each block diagram, each block represents a configuration of a functional unit instead of a configuration of a hardware unit unless otherwise described.

### Example Embodiment 1

### <Outline>

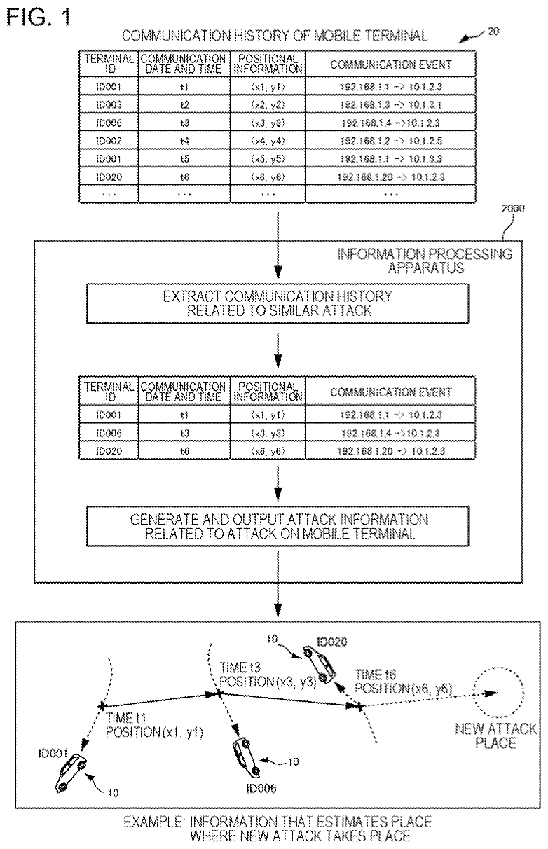

FIG. 1 is a diagram representing an outline of an operation of an information processing apparatus according to an example embodiment 1. FIG. 1 is a schematic diagram for facilitating understanding of the operation of the information processing apparatus 2000, and does not specifically limit the operation of the information processing apparatus 2000.

There is a terminal that performs network communication while moving, such as a terminal mounted on a vehicle. Hereinafter, such a terminal is referred to as a mobile terminal 10. Herein, the mobile terminal 10 performs network communication via an access point installed in a store and performs network communication and the like via a base station. Thus, a plurality of mobile terminals 10 may be connected to the same network. Further, the plurality of mobile terminals 10 may access a common apparatus (for example, a Web server, a DNS server, and the like).

The plurality of mobile terminals 10 that are connected to the same network and access the same apparatus in such a manner may suffer similar attack damage. For example, a malicious person takes control of a certain access point, and, as a result, each of the mobile terminals 10 that perform communication via the certain access point conceivably suffers the same attack damage. Note that the attack herein refers to any attack that affects network communication of the mobile terminal 10. For example, an attack that introduces malware to the mobile terminal 10, an attack that falsifies data exchanged in network communication between the mobile terminal 10 and another apparatus, and an attack that leaks information from the mobile terminal 10 to the outside are included.

In such a manner, in an environment in which there is a possibility that the plurality of mobile terminals 10 may suffer damage by the same attack, it is suitable to prevent beforehand an attack on the mobile terminal 10 that has not yet suffered attack damage by using information related to the mobile terminal 10 that has already suffered an attack. In this way, a probability that each of the mobile terminals 10 suffers attack damage can be reduced.

Thus, the information processing apparatus 2000 extracts, from a communication history 20 representing a history of network communication of the plurality of mobile terminals 10, the communication history 20 related to a similar attack, and generates information (hereinafter, attack information) related to an attack on the mobile terminal 10 by using the extracted communication history 20. Herein, the communication history 20 includes positional information about the mobile terminal 10. Then, the information processing apparatus 2000 generates attack information by using positional information indicated by each of the extracted communication histories 20.

In the example in FIG. 1, the information processing apparatus 2000 extracts the communication history 20 related to a similar attack, and estimates a place where a new attack takes place by using positional information indicated by each of the extracted communication histories 20. Then, the information processing apparatus 2000 generates attack information indicating the estimated place. By using the attack information, an attack can be avoided by performing a measure in such a way that a user of the mobile terminal 10 avoids a new attack place and moves, and the like, for example.

### <Advantageous Effect>

The information processing apparatus 2000 according to the present example embodiment extracts the communication history 20 of the mobile terminal 10 that has suffered a similar attack, and generates attack information having a content such as a place where a new attack takes place by using positional information about the mobile terminal 10 indicated by the extracted communication history 20. By using such attack information, the mobile terminal 10 that has not yet suffered an attack can be prevented beforehand from suffering attack damage. In this way, a probability that each of the mobile terminals 10 suffers attack damage can be reduced. Further, the mobile terminal 10 that has already suffered an attack can be prevented from suffering the same attack again.

Hereinafter, the information processing apparatus 2000 according to the present example embodiment will be described in more detail.

### <Example of Functional Configuration of Information Processing Apparatus 2000>

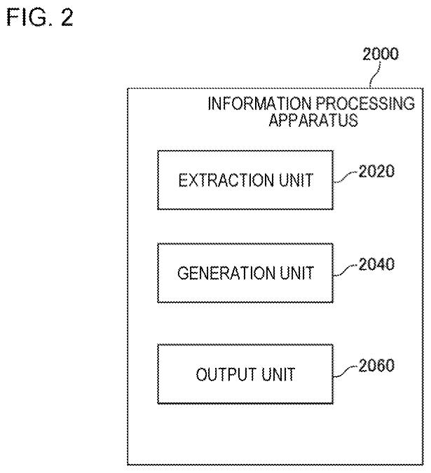

FIG. 2 is a diagram illustrating a configuration of the information processing apparatus 2000 according to the example embodiment 1. The information processing apparatus 2000 includes an extraction unit 2020, a generation unit 2040, and an output unit 2060. The extraction unit 2020 extracts, from the communication history 20 representing a history of network communication performed by each of the plurality of mobile terminals 10, the communication history 20 indicating communication related to a similar attack. The generation unit 2040 generates attack information related to an attack on the mobile terminal 10 by using positional information indicated by each of the extracted communication histories 20. The output unit 2060 outputs the attack information.

### <Hardware Configuration of Information Processing Apparatus 2000>

Each functional component unit of the information processing apparatus 2000 may be achieved by hardware (for example, a hard-wired electronic circuit and the like) that achieves each functional component unit, and may be achieved by a combination of hardware and software (for example, a combination of an electronic circuit and a program that controls the electronic circuit and the like). Hereinafter, a case where each functional component unit of the information processing apparatus 2000 is achieved by the combination of hardware and software will be further described.

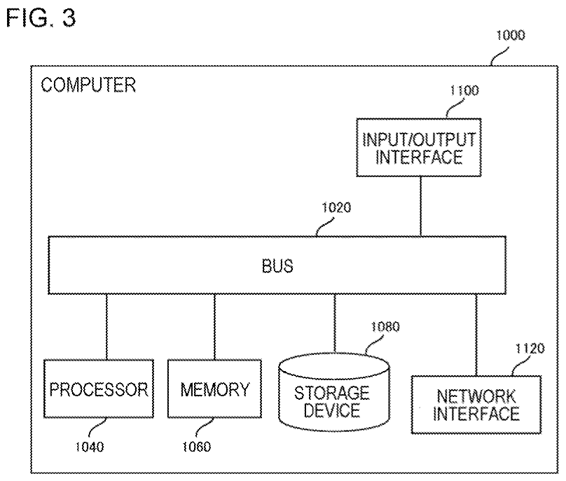

FIG. 3 is a diagram illustrating a computer 1000 for achieving the information processing apparatus 2000. The computer 1000 is any computer. For example, the computer 1000 is a desktop computer such as a personal computer (PC) and a server machine. In addition, for example, the computer 1000 is a portable computer such as a smartphone and a tablet terminal. The computer 1000 may be a dedicated computer designed for achieving the information processing apparatus 2000, and may be a general-purpose computer.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data with one another. However, a method of connecting the processor 1040 and the like to each other is not limited to a bus connection.

The processor 1040 is various types of processors such as a central processing unit (CPU), a graphic processing unit (GPU), and a field-programmable gate array (FPGA). The memory 1060 is a main storage apparatus achieved by using a random access memory (RAM) and the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard and an output apparatus such as a display apparatus are connected to the input/output interface 1100.

The network interface 1120 is an interface for connecting the computer 1000 to a communication network. The communication network is, for example, a local area network (LAN) and a wide area network (WAN). A method of connection to the communication network by the network interface 1120 may be a wireless connection or a wired connection.

The storage device 1080 stores a program module that achieves each functional component unit of the information processing apparatus 2000. The processor 1040 achieves a function associated with each program module by reading each of the program modules to the memory 1060 and executing the program module.

### <Flow of Processing>

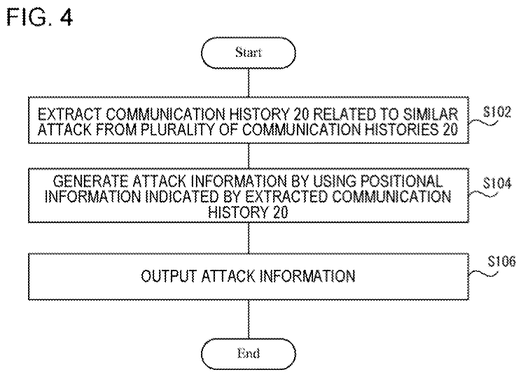

FIG. 4 is a flowchart illustrating a flow of processing performed by the information processing apparatus 2000 according to the example embodiment 1. The extraction unit 2020 extracts the communication history 20 indicating communication related to a similar attack from the plurality of communication histories 20 (S102). The generation unit 2040 generates attack information by using positional information indicated by each of the extracted communication histories 20 (S104). The output unit 2060 outputs the attack information (S106).

### <With Regard to Mobile Terminal 10>

The mobile terminal 10 is any computer that has a position moving and performs network communication. For example, the mobile terminal 10 is a computer mounted on a vehicle such as a car.

The mobile terminal 10 performs network communication via a wide area network (WAN). However, the mobile terminal 10 may include or may not include a network interface that can be directly connected to the WAN. In a latter case, the mobile terminal 10 is connected to the WAN via another apparatus including a network interface that can be directly connected to the WAN. For example, a case where a computer mounted on a vehicle is connected to the WAN (i.e., tethering is used) via a smartphone possessed by a passenger of the vehicle is conceivable.

### <With Regard to Communication History 20>

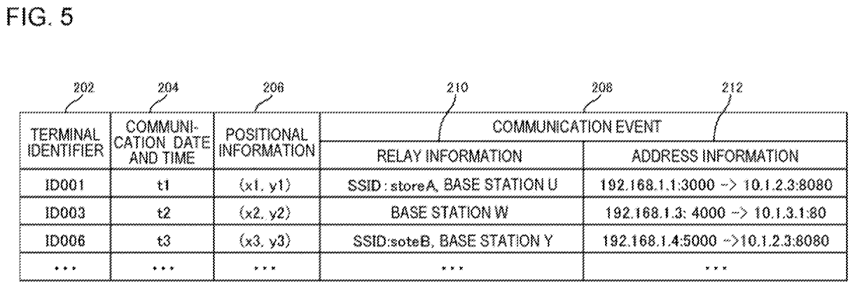

FIG. 5 is a diagram illustrating a configuration of the communication history 20 in a table format. The table illustrated in FIG. 5 is referred to as a table 200. The table 200 indicates a terminal identifier 202, communication date and time 204, positional information 206, and a communication event 208. Each record of the table 200 represents one communication history.

The terminal identifier 202 indicates an identifier of the mobile terminal 10 serving as a communication source (transmission source of data). In other words, the terminal identifier 202 indicates a history of network communication performed by which mobile terminal 10. Any identifier that can identify the mobile terminal 10 can be used as an identifier of the mobile terminal 10. For example, a universally unique identifier (UUID) and a network address (such as an Internet protocol (IP) address and a media access control (MAC) address) can be used as an identifier. In addition, for example, when the mobile terminal 10 is mounted on a vehicle, an identifier (for example, a number described on a number plate, and a vehicle identification number) of the vehicle mounted with the mobile terminal 10 may be used as an identifier of the mobile terminal 10.

The communication date and time 204 indicate a date and time at which communication is performed. The positional information 206 indicates positional information related to the mobile terminal 10 as a communication source. The positional information is, for example, positional information about the mobile terminal 10 itself and positional information about a smartphone and the like used for connection to the WAN by the mobile terminal 10. For example, global positioning system (GPS) coordinates acquired from a GPS sensor provided in a terminal can be used for positional information about the terminal. Further, GPS coordinates and an identifier of a relay apparatus described later may be indicated as positional information.

The communication event 208 indicates various types of information representing a communication event. In FIG. 5, the communication event 208 includes relay information 210 and address information 212. The relay information 210 indicates an identifier of a relay apparatus (such as a proxy server, an access point, or a base station) used when the mobile terminal 10 as a communication source is connected to a network. For example, an identifier similar to an identifier of the mobile terminal 10 can be used as an identifier of a relay apparatus. Further, an SSID can also be used as an identifier of an access point.

The address information 212 indicates, for example, information such as a network address and a port number for each of the mobile terminal 10 as a communication source and an apparatus as a communication destination. The address information 212 in FIG. 5 indicates information in a form of an “IP address of a communication source: a port number ->an IP address of a communication destination: a port number”. Note that, when a network address of the mobile terminal 10 as a communication source is used as the terminal identifier 202, address information about the communication source may be omitted.

The information processing apparatus 2000 extracts a desired communication history from a database (hereinafter, a communication history database) in which the communication history 20 is stored. A server constituting the communication history database performs collection of a communication history. The server may be the information processing apparatus 2000, or may be an apparatus other than the information processing apparatus 2000.

A method of performing collection of a communication history is any method. For example, each of the mobile terminals 10 periodically transmits a history of network communication performed by the mobile terminal 10 to a database server.

Note that a part of information included in a communication history may be generated later by using collected information. For example, positional information about the mobile terminal 10 is conceivably generated by using other information in which behavior of the mobile terminal 10 is recorded. For example, it is assumed that a number of a number plate is used as an identifier of the mobile terminal 10. In this case, a position of a security camera can be used as positional information about a vehicle by determining a number of each vehicle captured by the security camera by analyzing video of the security camera installed at various places. In other words, when a number of a certain vehicle is captured by a security camera, an identifier of the security camera, GPS coordinates of the security camera, and the like can be used as positional information about the vehicle at a point in time of the capturing.

### <Extraction of Communication History 20: S102>

The extraction unit 2020 extracts the communication history 20 related to a similar attack (S102). In other words, the extraction unit 2020 extracts the communication history 20 performed by one or more mobile terminals 10 that have suffered a similar attack. The similar attack is, for example, an attack in which at least one of an attacker and a type of the attack is common.

For this reason, for example, an extraction rule for extracting the communication history of the mobile terminal 10 that has suffered a similar attack is determined in advance. The extraction unit 2020 extracts the communication history 20 performed by a similar attack by searching the communication history database, based on the extraction rule. For example, as described later, for the plurality of mobile terminals 10 that have commonly suffered an attack that causes connection to a malicious apparatus, an apparatus having the same identifier is a communication destination. Thus, by an extraction rule that an “identifier of an apparatus as a communication destination is common”, the communication history 20 of the plurality of mobile terminals 10 that have suffered the attack can be extracted. The extraction rule is stored in advance in a storage device that can be accessed from the extraction unit 2020.

Herein, the extraction unit 2020 may determine whether to perform extraction of the communication history 20 depending on an amount of the communication history 20 that coincides with the extraction rule. For example, when the number of the communication histories 20 that coincide with the same extraction rule is equal to or more than a predetermined number, the extraction unit 2020 extracts the communication history 20. On the other hand, when the number of the communication histories 20 that coincide with the same extraction rule is less than the predetermined number, the extraction unit 2020 does not extract the communication history 20.

At this time, the extraction unit 2020 may limit communication date and time being a target. For example, when the number of the communication histories 20 that coincide with the same extraction rule and whose communication date and time fall within a predetermined period (for example, the same day) is equal to or more than the predetermined number, the extraction unit 2020 performs extraction of the communication history 20. Further, the extraction unit 2020 may use a proportion (rate of the number of the communication histories 20 that coincide with an extraction rule to the number of the entire communication histories 20) of the communication history 20 instead of the number of the communication histories 20.

Note that, when specific information related to an attack, such as an identifier of an apparatus used for the attack, is identified, such specific information may be included in an extraction rule. For example, when an IP address of an apparatus as a connection destination is identified for an attack that causes connection to a malicious apparatus, an extraction rule that an “identifier of an apparatus as a communication destination =an identified IP address” can be used.

Herein, various types of information according to a type of an attack may be adopted for an extraction rule. Hereinafter, an extraction rule related to an attack of a type will be illustrated together with the type of the attack.

### Example 1: Man-in-the-Middle Attack

For example, a man-in-the-middle attack by a relay apparatus is conceivable as an attack on the mobile terminal 10. The man-in-the-middle attack is an attack by a man in the middle being interposed between apparatuses that perform communication with each other. In this way, an attack that falsifies data in such a way that false data are provided to the mobile terminal 10 as a communication source and an apparatus as a communication destination, and introduces malware to the mobile terminal 10 by introducing malware to data transmitted to the mobile terminal 10 as a communication source can be achieved.

When the plurality of mobile terminals 10 suffer a similar man-in-the-middle attack, it is conceivable that the mobile terminals 10 use a common relay apparatus. Thus, for example, an “identifier of a relay apparatus is common” is determined in advance as an extraction rule. Further, when an identifier of a relay apparatus used for the attack is identified, the identifier may be included in the extraction rule.

In addition, for example, when a man-in-the-middle attack is made, there is also a case where an identifier of the man in the middle is a destination of a packet transmitted from the portable terminal 10 (i.e., the man in the middle is an apparatus as a communication destination). For example, when the mobile terminal 10 accesses a network via a proxy server, a destination IP address of a packet transmitted from the mobile terminal 10 is an IP address of the proxy server. Thus, the communication history 20 when a man-in-the-middle attack takes place by the proxy server indicates, as an identifier of an apparatus as a communication destination, an identifier of the proxy server being a man in the middle. Further, when the portable terminal 10 constructs a virtual private network (VPN) between a specific apparatus and the portable terminal 10 and performs communication, the portable terminal 10 and the apparatus exchange data via a VPN server. Thus, a destination IP address of a packet transmitted from the portable terminal 10 is an IP address of the VPN server.

When the plurality of mobile terminals 10 suffer a similar man-in-the-middle attack in the above-described case, it is conceivable that the mobile terminals 10 have a common apparatus as a communication destination. Thus, for example, an “identifier of an apparatus as a communication destination is common” is determined in advance as an extraction rule. Further, when an identifier of the proxy server and the VPN server used for the attack is identified, the identifier may be included in the extraction rule.

### Example 2: DNS Hijack

In addition, for example, as an attack on the mobile terminal 10, an attack that “causes the mobile terminal 10 to be connected to a malicious apparatus by changing a communication destination of the mobile terminal 10 to the malicious apparatus different from the originally intended communication destination by using DNS Hijack” is conceivable. In this way, an attack that provides false information to the mobile terminal 10, and introduces malware to the mobile terminal 10 by transmitting malware to the mobile terminal 10 can be achieved.

When the plurality of mobile terminals 10 suffer a similar attack by DNS Hijack, it is conceivable that the mobile terminals 10 use the same apparatus as a communication destination, for example. Thus, for example, an “identifier of an apparatus as a communication destination is common” is determined in advance as an extraction rule. Further, when an identifier of an apparatus used for the attack is identified, the identifier may be included in the extraction rule.

In addition, for example, in DNS Hijack, even when domains requested of a name resolution by the plurality of mobile terminals 10 are different from each other, it is conceivable that a DNS server returns an IP address of the same unauthorized site. Thus, when a used DNS server is the same, there is a possibility that the same attack may be made regardless of a communication destination.

Thus, for example, the communication history 20 is configured in advance in such a way as to include an identifier of the DNS server used for the name resolution. Then, an “identifier of a used DNS server is common” is determined in advance as an extraction rule. Further, when an identifier of a DNS server used for the attack is identified, the identifier may be included in the extraction rule.

Further, there is also a case where a DNS server used by the mobile terminal 10 is set in advance in a relay apparatus such as an access point and a base station. Thus, the mobile terminal 10 that uses the same access point or the same base station may suffer damage by common DNS Hijack.

Thus, for example, an “identifier of a relay apparatus is common” is determined in advance as an extraction rule. Further, when an identifier of a relay apparatus used for the attack is identified, the identifier may be included in the extraction rule.

### Example 3: Attack by Another Person Who Obtains Mobile Terminal 10

Another person may temporarily acquire (for example, entrust) the mobile terminal 10, a computer system (such as a vehicle) in which the mobile terminal 10 is provided, and the like. For example, when the mobile terminal 10 is provided in a vehicle, it is conceivable that the vehicle is entrusted to another person (such as a dealer and a factory) in order to request an inspection, a repair, and the like of the vehicle. In such a case, an attack that causes connection to the mobile terminal 10 by the another person adding malware to the mobile terminal 10 or adding an unauthorized apparatus to a system is conceivable.

When such an attack is made, configuration information representing a software configuration of the mobile terminal 10 and a configuration of peripheral equipment is changed. Then, such configuration information may be managed on a network. Thus, the communication history 20 representing a change in the configuration information can be extracted as the communication history 20 by the mobile terminal 10 that has suffered the attack.

Herein, in each piece of communication representing a change in configuration information, a management server that manages the configuration information is conceivably assumed to be a common communication destination. Further, a common configuration changed by an attack is conceivably indicated as a content of a payload.

Thus, an “identifier of an apparatus as a communication destination is common” and a “content of a payload of communication is common” are determined in advance as an extraction rule. Further, when data commonly included in an identifier of a server that manages configuration information and a payload of communication for updating the configuration information are identified, the data may be included in the extraction rule.

### Example 4: Introduction of Malware by Apparatus to which Mobile Terminal 10 is Physically Connected

The mobile terminal 10 may be physically connected to an external device. For example, the mobile terminal 10 may be connected to a charger prepared in a store and the like in order to charge the mobile terminal 10. At this time, the mobile terminal 10 may be connected to the charger in a manner that allows data communication. For example, when the charger supplies electric power via a USB interface, the mobile terminal 10 and the charger are connected to each other via a USB cable. When the charger is a malicious apparatus, there is a risk that malware may be introduced to the mobile terminal 10 from the charger. In this case, the plurality of mobile terminals 10 connected to the same charger suffer the same attack.

Herein, it is conceivable that the same malware is introduced to the mobile terminal 10 that has suffered the same attack. Then, when the malware performs network communication, it can be said that there is a common feature in communication performed by the mobile terminal 10 that has suffered the same attack. The common feature is, for example, an identifier of an apparatus as a communication destination and a content (i.e., a content of a payload) of data exchanged with a communication destination.

Thus, an “identifier of an apparatus as a communication destination is common” and a “content of a payload is common” are determined in advance as an extraction rule. Further, when an identifier of an apparatus as a communication destination of the malware introduced by the above-described attack and a content of a payload exchanged with the apparatus as the communication destination by the malware are identified, the identifier and the content may be included in the extraction rule.

### <<With Regard to Damage by Attack>>

As damage by various types of the attacks mentioned above, for example, damage in which malware is introduced to the mobile terminal 10 is conceivable. Further, as specific damage that occurs by malware introduced to the mobile terminal 10, a leakage of secret information, a system failure, and the like are conceivable. As leaking secret information, there is, for example, a secret key, credit card information, a password, personal information, positional information, or the like. Further, as a system failure, there are, for example, damage (for example, ransomware) in which data on a system are encrypted, various types of control failures that occur due to malware being interposed in processing performed by a control system of equipment such as a vehicle, and the like.

As another example of damage by an attack, falsification of communication data is conceivable. As specific damage by falsification of communication data, for example, confusion for a user being caused by providing false information to the mobile terminal 10 is conceivable. For example, when false positional information is given to a car navigation system, there is a risk that false navigation may be performed. In addition, for example, it is also conceivable that a system failure is caused by giving a false parameter to a control system.

### <Generation of Attack Information: S104>

The generation unit 2040 generates attack information (S104). The attack information is, for example, information related to a future attack on the mobile terminal 10. For example, the generation unit 2040 estimates a place where a new attack takes place by using positional information indicated by the communication history extracted by the extraction unit 2020, and generates attack information indicating the estimated place. The mobile terminal 10 can avoid the place and move by being notified of the attack information, and thus new attack damage can be reduced.

Herein, various types of information that determine a place where an attack takes place can be used. For example, the place can be determined by a name, an address, GPS coordinates, or the like of the place. In addition, for example, an identifier (such as an SSID) of an access point of wireless communication installed at the place may be used as information that determines the place.

The generation unit 2040 estimates a place where a new attack takes place by using the extracted communication history 20. Specifically, the generation unit 2040 generates, by using positional information indicated by each of the communication histories 20, time series data representing a time change in the positional information. Then, generation unit 2040 determines a time change in attack place by using the time series data, and estimates a new attack place, based on the time change.

For example, it is assumed that a change in positional information is small (for example, a distance from the farthest position is equal to or less than a threshold value) in time series data of the positional information. In this case, it is conceivable that an attack continues at the same place. Thus, for example, the generation unit 2040 estimates, as a place where a new attack takes place, a place determined by position information of each of the extracted communication histories 20. For example, the generation unit 2040 obtains an average of GPS coordinates indicated by the positional information of each of the communication histories 20, and calculates, as information representing a place where a new attack takes place, the GPS coordinates representing the average. In addition, for example, the generation unit 2040 may set, as information representing a place where a new attack takes place, a name, an address, and the like of a place associated with the calculated GPS coordinates.

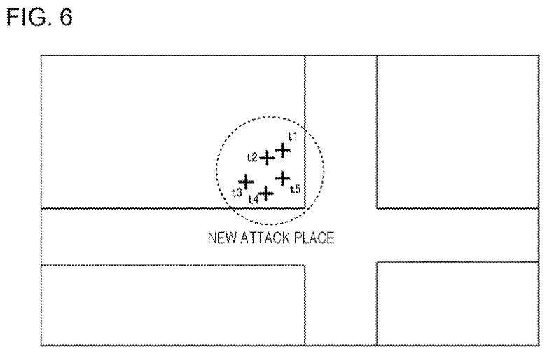

FIG. 6 is a diagram illustrating a case where a change in positional information is small in time series data of the positional information acquired from the extracted communication history 20. For example, FIG. 6 represents attack information including a map. A cross mark represents the positional information indicated in the communication history 20 extracted by the extraction unit 2020. In this case, a time change in the positional information is small, and thus the generation unit 2040 estimates an area including each piece of the positional information as a place where a new attack takes place, and generates attack information representing the place by a dotted line.

On the other hand, it is assumed that a change in positional information is great (for example, a distance from the farthest position is greater than a threshold value) in time series data of the positional information. In this case, the generation unit 2040 estimates a movement path of an attack place, based on a time change in the positional information, and estimates each position on the movement path as a future attack place. Herein, an existing technique can be used as a technique for predicting a future movement path of a certain object by using a time change in positional information about the certain object. For example, map information is used for the prediction. The map information may be stored in advance in a storage device that can be accessed from the information processing apparatus 2000, and may be acquired from any server that provides the map information.

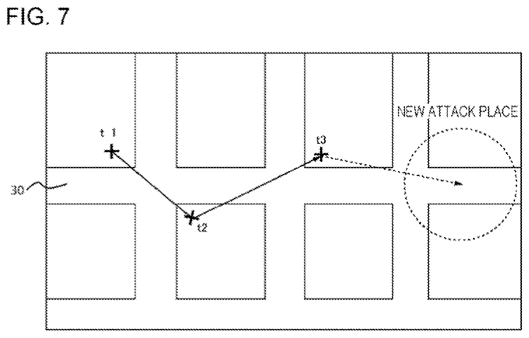

FIG. 7 is a diagram illustrating a case where a change in positional information is great in time series data of the positional information acquired from the extracted communication history 20. It is clear from FIG. 7 that the positional information moves in a right direction along a road 30. Thus, the generation unit 2040 estimates, as a place where a new attack takes place, a place moved in the right direction along the road 30, and generates attack information indicating the place by a dotted line on a map.

Further, the generation unit 2040 may compare a movement path of each of the mobile terminals 10 with the time series data mentioned above, and determine the mobile terminal 10 moving on a path similar to the time series data. There is a high probability that the mobile terminal 10 moving on the path similar to the time series data mentioned above is the mobile terminal 10 of an attacker. Thus, the generation unit 2040 includes, in attack information, an identifier of the determined mobile terminal 10 as information indicating the mobile terminal 10 estimated to be an attacker. Note that the movement path of the mobile terminal 10 can be determined from a time-series change in positional information about the mobile terminal 10.

### <<Narrowing of Communication History Used for Generation of Attack Information>>

The generation unit 2040 may generate attack information by using a part of the communication history 20 extracted by the extraction unit 2020 instead of the entire communication history 20. For example, the generation unit 2040 narrows down the communication history 20 used for generation of attack information by excluding the communication history 20 having communication date and time greatly different from those of the other communication history 20 from among the extracted communication histories 20. As a more specific example, the generation unit 2040 calculates an average μ and a standard deviation σ of communication date and time indicated by the extracted communication history 20, and generates attack information by using only the communication history 20 having the communication date and time included in a range of μ±σ.

Further, the generation unit 2040 may further divide the communication histories 20 extracted by the method described above into groups, and generate attack information for each group. For example, the generation unit 2040 clusters the extracted communication history 20, based on communication date and time, and generates attack information for each cluster. Note that various types of existing techniques can be used as a clustering technique.

### <Output of Attack Information: S106>

The output unit 2060 outputs the attack information (S106). Hereinafter, a content, an output destination, and the like of the attack information will be described.

### <<Content of Attack Information>>

For example, the output unit 2060 generates attack information including information related to a place where a new attack takes place. Information that determines a place where a new attack takes place and a method of determining the place are as mentioned above.

Note that information related to a place where a new attack takes place is suitably represented in a form easily understood by a person. For example, similarly to the attack information illustrated in FIGS. 6 and 7, it is suitable to use a map on which information (for example, a shape, an icon, and the like) representing the place is superimposed, and the like. In this way, a user of the mobile terminal 10 can easily recognize a place where a new attack takes place.

In addition, for example, the output unit 2060 may generate attack information indicating a history of a place where an attack has already taken place. For example, the information is information that indicates, on a map, a movement path (time series data of positional information of each of the communication histories 20 extracted by the extraction unit 2020) of the place where the attack takes place in a manner in which a movement direction of the movement path is clear. When a user of the mobile terminal 10 views such information, the user himself/herself can predict a future attack place to a certain degree.

### <<Output Destination>>

For example, the output unit 2060 transmits attack information to the mobile terminal 10. The mobile terminal 10 serving as a destination may be all or a part of the mobile terminals 10 that can be specified as a destination. In a latter case, the output unit 2060 sets, as a destination, the mobile terminal 10 having a high probability of suffering a new attack. The mobile terminal 10 having a high probability of suffering a new attack is the mobile terminal 10 located at a place where a new attack takes place being estimated by the generation unit 2040, or the mobile terminal 10 heading toward the place. Herein, the mobile terminal 10 heading toward a certain place can include not only the mobile terminal 10 moving with the place as a goal, but also the mobile terminal 10 passing through the place.

When a part of the mobile terminals 10 is set as a destination, the information processing apparatus 2000 needs to be able to recognize a position of each of the mobile terminals 10. Thus, for example, positional information about each of the mobile terminals 10 is collected similarly to the communication history 20, and is stored in a storage device that can be accessed by the information processing apparatus 2000. For example, positional information is collected and managed together with a communication history.

Further, in order to determine whether a certain mobile terminal 10 heads toward a place where a new attack takes place, a movement path of the mobile terminal 10 needs to be recognized. For example, the output unit 2060 estimates a future movement path of each of the mobile terminals 10 by using time series data of positional information acquired from each of the mobile terminals 10, and thus determines whether each of the mobile terminals 10 heads toward a place where a new attack takes place.

In addition, for example, when the mobile terminal 10 uses a car navigation system, the output unit 2060 may recognize a movement path of the mobile terminal, based on goal information set in a car navigation system and information about a recommended movement path presented by the car navigation system. In this case, the information handled by the car navigation system is also collected and managed similarly to positional information about the mobile terminal 10.

It is suitable that attack information transmitted to the mobile terminal 10 is received by the mobile terminal 10 and is then output in such a way as to be recognizable by a user of the mobile terminal 10. For example, attack information is set to be displayed on a display apparatus (for example, a display apparatus used by a car navigation system) provided in the mobile terminal 10.

In addition, for example, attack information may be output to an apparatus that achieves a car navigation system, and a recommended movement path provided by the car navigation system may be changed, based on a future attack place indicated by the attack information. Specifically, the car navigation system calculates a new movement path for avoiding a future attack place and reaching a goal by using attack information, and presents the calculated new movement path.

In addition, for example, when the mobile terminal 10 is provided in an autonomous car, a movement path of the autonomous car may be changed by using attack information. The method is similar to a method of changing a recommended movement path provided by a car navigation system.

An output destination of attack information may be other than the mobile terminal 10. For example, the output unit 2060 causes any storage device that can be accessed from the information processing apparatus 2000 to store attack information. In addition, for example, the output unit 2060 may display attack information on a display apparatus connected to the information processing apparatus 2000. In this way, a user (for example, an administrator, a security analyst, and the like of the information processing apparatus 2000) of the information processing apparatus 2000 can recognize information related an attack.

In addition, for example, attack information may be open to the public via a Web server and the like. In this way, various people can recognize information related to an attack. Note that the information processing apparatus 2000 may function as a Web server, or a Web server machine may be separately prepared. In a latter case, the output unit 2060 transmits attack information to a server machine being separately prepared, or causes a storage device that can be accessed from the server machine to store the attack information.

While the example embodiment of the present invention has been described with reference to the drawings, the example embodiment is only exemplification of the present invention, and combination of each above-described example embodiment or various configurations other than the above-described example embodiment can also be employed.

What is claimed is:

1. An information processing apparatus, comprising:
an extraction unit that extracts, from a communication history representing a history of network communication performed by each of a plurality of mobile terminals, a communication history indicating communication related to a similar attack,
the communication history including positional information about the mobile terminal;
a generation unit that generates attack information related to an attack on a mobile terminal by using positional information indicated by each of the extracted communication histories; and
an output unit that outputs the generated attack information.

2. The information processing apparatus according to claim 1, wherein
the extraction unit acquires an extraction rule for determining a communication history indicating communication related to a similar attack, and extracts a communication history that coincides with the extraction rule.

3. The information processing apparatus according to claim 2, wherein
the communication history further indicates any one or more of an identifier of a terminal as a communication destination, an identifier of a relay apparatus used in communication, an identifier of a DNS server used in communication, and a content of communicated data, and
the extraction rule indicates a rule related to any one or more of an identifier of a terminal as the communication destination, an identifier of the relay apparatus, an identifier of the DNS server, and a content of the communicated data, that are indicated by the communication history.

4. The information processing apparatus according to claim 1, wherein
the generation unit estimates a place where a new attack takes place by using positional information indicated by each of the extracted communication histories, and generates the attack information indicating the estimated place.

5. The information processing apparatus according to claim 4, wherein the place is determined by an identifier of an access point used by a mobile terminal located at the place.

6. The information processing apparatus according to claim 5, wherein the output unit outputs the attack information to at least one of a mobile terminal located near the estimated place and a mobile terminal heading toward the estimated place.

7. The information processing apparatus according to claim 1, wherein
the communication history indicates a point in time of communication being a point in time at which communication is performed, and
the generation unit generates the attack information including path information representing a time-series change in positional information by using a combination of positional information acquired from each of the extracted communication histories and a point in time of communication.

8. The information processing apparatus according to claim 7, wherein
the generation unit determines a mobile terminal that moves on a path similar to a path indicated by the path information by using the communication history, and generates the attack information including an identifier of the determined mobile terminal.

9. The information processing apparatus according to claim 1 wherein
the mobile terminal is mounted on a vehicle or is communicably connected to a vehicle.

10. A control method executed by a computer, the control method comprising:
an extraction step of extracting, from a communication history representing a history of network communication performed by each of a plurality of mobile terminals, a communication history indicating communication related to a similar attack,
the communication history including positional information about the mobile terminal;
a generation step of generating attack information related to an attack on a mobile terminal by using positional information indicated by each of the extracted communication histories; and
an output step of outputting the generated attack information.

11. The control method according to claim 10, wherein
the extraction step includes acquiring an extraction rule for determining a communication history indicating communication related to a similar attack, and extracting a communication history that coincides with the extraction rule.

12. The control method according to claim 11, wherein
the communication history further indicates any one or more of an identifier of a terminal as a communication destination, an identifier of a relay apparatus used in communication, an identifier of a DNS server used in communication, and a content of communicated data, and
the extraction rule indicates a rule related to any one or more of an identifier of a terminal as the communication destination, an identifier of the relay apparatus, an identifier of the DNS server, and a content of the communicated data, that are indicated by the communication history.

13. The control method according to claim 10, wherein
the generation step includes estimating a place where a new attack takes place by using positional information indicated by each of the extracted communication histories, and generating the attack information indicating the estimated place.

14. The control method according to claim 13, wherein
the place is determined by an identifier of an access point used by a mobile terminal located at the place.

15. The control method according to claim 14, wherein
the output step includes outputting the attack information to at least one of a mobile terminal located near the estimated place and a mobile terminal heading toward the estimated place.

16. The control method according to claim 10, wherein
the communication history indicates a point in time of communication being a point in time at which communication is performed, and
the generation step includes generating the attack information including path information representing a time-series change in positional information by using a combination of positional information acquired from each of the extracted communication histories and a point in time of communication.

17. The control method according to claim 16, wherein
the generation step includes determining a mobile terminal that moves on a path similar to a path indicated by the path information by using the communication history, and generating the attack information including an identifier of the determined mobile terminal.

18. The control method according claim 10, wherein
the mobile terminal is mounted on a vehicle or is communicably connected to a vehicle.

19. A non-transitory computer readable medium having recorded thereon a program causing a computer to execute each step of the control method according to claim 10.
